(19) United States
(12) Patent Application Publication
(10) Pub. No.: US 2023/0028381 A1
(43) Pub. Date: Jan. 26, 2023

(54) ENTERPRISE KNOWLEDGE BASE SYSTEM FOR COMMUNITY MEDIATION

(71) Applicant: Microsoft Technology Licensing, LLC, Redmond, WA (US)

(72) Inventors: Dmitriy MEYERZON, Bellevue, WA (US); Victor POZNANSKI, Sammamish, WA (US); Nikita VORONKOV, Bothell, WA (US); Ryen W. WHITE, Woodinville, WA (US); Eric GRADEL, Seattle, WA (US); Mark J. ENCARNACIÓN, Bellevue, WA (US); Kerem YUCETURK, Bellevue, WA (US); Michael GAMON, Seattle, WA (US); Nirupama CHANDRASEKARAN, Seattle, WA (US); Silviu-Petru CUCERZAN, Redmond, WA (US); Keith Richard CHAMBERS, Redmond, WA (US); John William BACUS, Seattle, WA (US); Aaron Lee HALFAKER, Seattle, WA (US); James S. WOFFINDEN-LUEY, Redmond, WA (US); Youngji KIM, Bellevue, WA (US)

(73) Assignee: Microsoft Technology Licensing, LLC, Redmond, WA (US)

(21) Appl. No.: 17/381,110

(22) Filed: Jul. 20, 2021

(51) Int. Cl. G06N 5/02; G06N 5/04; G06F 40/30; G06F 16/332

(52) U.S. Cl. CPC G06N 5/022; G06N 5/04; G06F 40/30; G06F 16/3326

(57) ABSTRACT

Systems and methods for facilitating an enterprise user to obtain an answer to a user question within an enterprise based on an enterprise knowledge graph are provided. In particular, an enterprise server may receive the user question from the enterprise user, determine a suggested topic associated with the user question based on the enterprise knowledge graph by transforming the user question into a semantic representation to identify a plurality of similar entities within the enterprise knowledge graph, and determine whether a relevant question-and-answer (Q&A) pair linked to the suggested topic exists based on the enterprise knowledge graph. In response to a determination that the relevant Q&A pair does not exist, the enterprise server may determine a predicted answer to the user question and update the enterprise knowledge graph.

### BACKGROUND

Search engines are designed to provide answers or relevant information to various questions posted by users based on stores of knowledge. Such a store of knowledge is referred to as a knowledge graph or knowledge base and comprises facts about entities (e.g., objects, events, situations, or abstract concepts) and relations between the entities.

In an enterprise setting, many different applications are available to users to post questions, including discussion forums (e.g., enterprise social networking service for private communication within organization), group chat, and/or e-mail. Oftentimes, data in the enterprise is also sparse, making it difficult for the search engine to find answers. Another problem is that enterprise users often won't know which community or group to post the question to or which people to ask. Additionally, enterprise search is typically limited to answering short navigational queries since oftentimes answers or related information to the question include confidential material.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with at least one example of the present disclosure, a method for facilitating an enterprise user to obtain an answer to a user question within an enterprise based on an enterprise knowledge graph is provided. The method may include receiving the user question from the enterprise user, determining a suggested topic associated with the user question based on the enterprise knowledge graph by transforming the user question into a semantic representation to identify a plurality of similar entities within the enterprise knowledge graph, determining whether a relevant question-and-answer (Q&A) pair linked to the suggested topic exists based on the enterprise knowledge graph, in response to determining that the relevant Q&A pair does not exist, determining a predicted answer to the user question by identifying one or more related enterprise documents linked to the suggested topic based on the enterprise knowledge graph and finding the predicted answer by matching the semantic representation of the user question to a corresponding semantic representation in the one or more related enterprise documents, updating the enterprise knowledge graph based on the user question and the predicted answer, and in response to determining the predicted answer to the user question, causing the predicted answer to be provided to the enterprise user.

In accordance with at least one example of the present disclosure, a computing device for facilitating an enterprise user to obtain an answer to a user question within an enterprise based on an enterprise knowledge graph is provided. The computing device may include a processor and a memory having a plurality of instructions stored thereon that, when executed by the processor, causes the computing device to receive the user question from the enterprise user, determine a suggested topic associated with the user question based on the enterprise knowledge graph by paraphrasing the user question to identify a plurality of similar entities within the enterprise knowledge graph to provide the suggested topic, determine whether a relevant question-and-answer (Q&A) pair linked to the suggested topic exists based on the enterprise knowledge graph, in response to determination that the relevant Q&A pair does not exist, determine a predicted answer to the user question by identifying one or more related enterprise documents linked to the suggested topic based on the enterprise knowledge graph and finding the predicted answer by matching the paraphrased user question to the one or more related enterprise documents, update the enterprise knowledge graph based on the user question and the predicted answer, and in response to determination of the predicted answer to the user question, cause the predicted answer to be provided to the enterprise user.

In accordance with at least one example of the present disclosure, a non-transitory computer-readable medium storing instructions for facilitating an enterprise user to obtain an answer to a user question within an enterprise based on an enterprise knowledge graph is provided. The instructions when executed by one or more processors of a computing device, cause the computing device to receive the user question from the enterprise user, determine a suggested topic associated with the user question based on the enterprise knowledge graph by paraphrasing the user question to identify a plurality of similar entities within the enterprise knowledge graph to provide the suggested topic, determine whether a relevant question-and-answer (Q&A) pair linked to the suggested topic exists based on the enterprise knowledge graph, in response to determination that the relevant Q&A pair does not exist, determine an expert to answer the user question by identifying related people from the enterprise knowledge graph, in response to receipt of an expert answer, update the enterprise knowledge graph based on the user question and the expert answer, and cause the expert answer to be provided to the enterprise user, wherein determining the expert to answer the user question comprises determining the expert based on availability and likelihood of the related people to answer the user question.

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts details directed to an enterprise knowledge base system in accordance with examples of the present disclosure;

FIGS. 2-4 depict a method directed to facilitating users to obtain answers to their questions within an enterprise based on an enterprise knowledge graph in accordance with examples of the present disclosure

FIG. 5 depicts a block diagram illustrating physical components (e.g., hardware) of a computing device with which aspects of the disclosure may be practiced;

FIG. 6A illustrates a first example of a computing device with which aspects of the disclosure may be practiced;

FIG. 6B illustrates a second example of a computing device with which aspects of the disclosure may be practiced; and

FIG. 7 illustrates at least one aspect of an architecture of a system for processing data in accordance with examples of the present disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In an enterprise setting, many different applications are available to users (i.e., members of an enterprise) to post questions, including discussion forums (e.g., enterprise social networking service for private communication within organization), group chat, and/or e-mail. This makes finding answers particular challenging because the users may not know to which group (e.g., which community or department in the enterprise) to post a user question and/or to whom (e.g., which people) to address the question in order to maximize the likelihood of getting an answer.

An enterprise knowledge base system of the present disclosure is configured to facilitate obtaining answers to user questions within the enterprise based on an enterprise knowledge graph. The enterprise knowledge graph is a knowledge base that is unique to each enterprise and uses a structured data model to integrate a variety of sources within the enterprise, such as file systems, intranets, document management systems, e-mail, and databases. Additionally, the knowledge base is a collection of topic entities, with topic names, and other metadata related to topic, such as people, documents, sites, relevant groups, forums, etc.

By utilizing the enterprise knowledge graph, the enterprise knowledge base system may find a similar question in Q&A history linked to a topic associated with the user question. The Q&A history includes questions and answers that have previously been asked by other users in the enterprise. In the illustrative aspect, the enterprise knowledge base system may find a similar question by paraphrasing contents of the user question and questions in the Q&A history. For example, paraphrasing the user question may include transforming the user question into a semantic representation. In other words, paraphrasing the contents allows the enterprise server to identify one or more questions that are similar or related to (rather than explicitly matching) the user question within the enterprise knowledge graph.

Additionally, even if there is no Q&A history linked to the topic associated with the user question, the enterprise knowledge base system may determine and provide an answer to the user question by identifying related documents linked to the topic within the enterprise based on the enterprise knowledge graph. In response, the enterprise knowledge base system may generate a Q&A pair to be stored in the enterprise knowledge graph by paragraphing user question and the contents in the related documents may be paraphrased (e.g., transformed into semantic representations). If an answer cannot be found in the enterprise knowledge graph, the enterprise knowledge base system may suggest one or more experts to answer the user question by identifying related people within the enterprise from the enterprise knowledge graph. In other words, the enterprise knowledge base system may seamlessly integrate human feedback and direct communication with experts when an answer is not identified in the enterprise knowledge graph.

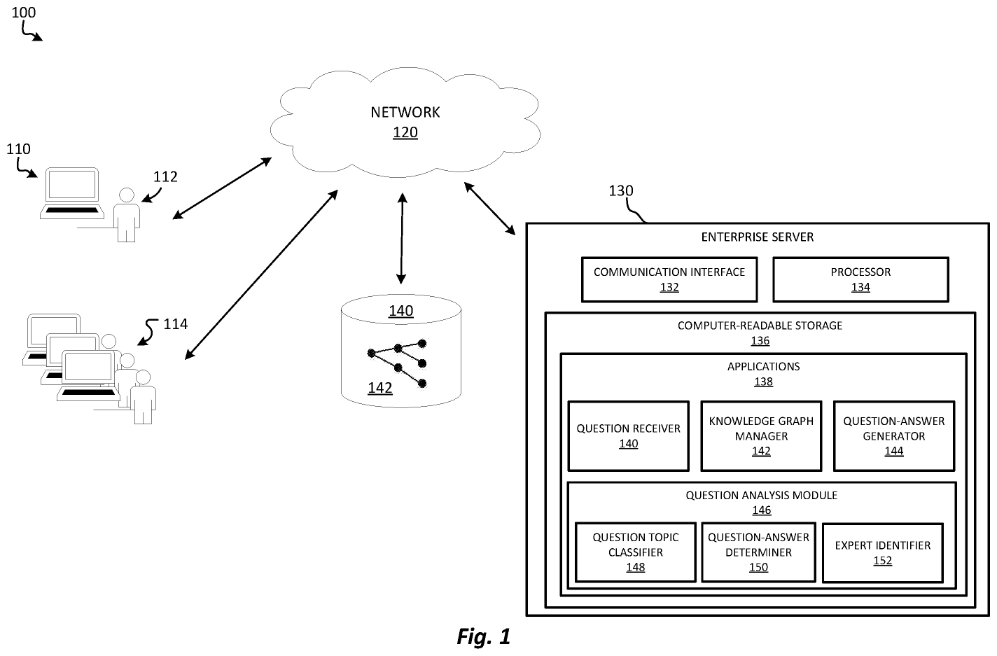

Referring now to FIG. 1, an enterprise knowledge base system 100 for facilitating obtaining answers to user questions within an enterprise based on an enterprise knowledge graph in accordance with examples of the present disclosure is provided. To do so, the enterprise knowledge base system 100 includes a computing device 110 associated with a user 112 and an enterprise server 130 that is communicatively coupled to the computing device 110 via a network 120. The enterprise server 130 is further configured to access the enterprise knowledge graph 142 stored in database 140 via the network 120. The network 120 may include any kind of computing network including, without limitation, a wired or wireless local area network (LAN), a wired or wireless wide area network (WAN), and/or the Internet.

In examples, a member of the enterprise (e.g., user 112) may utilize the computing device 110 to post a question on an enterprise server platform executed by the enterprise server 130 seeking an answer or information related to the question. Specifically, in the illustrative embodiment, the enterprise server platform allows the user 112 to post the question without selecting or specifying a related topic or specifying to which group (e.g., which community or department in the enterprise) and/or to whom (e.g., which people in the enterprise) the question should be addressed in order to obtain an answer or relevant information. In response, the enterprise knowledge base system 100 may lookup previously asked similar questions, lookup in enterprise documents of possible answers, and/or involve human experts on a topic to answer. However, it should be appreciated that, in some embodiments, the user may provide or select a topic that is related to the user question.

The computing device 110, although depicted as a desktop computer in FIG. 1 for example, may be any one of a portable or non-portable computing device. For example, the computing device 120 may be, but is not limited to, a computer, a desktop, a notebook, a laptop, a mobile device, a smartphone, a tablet, a wearable electronic device, an intelligent home appliance, or any other suitable computing device that is capable of communicating with the server 130.

The enterprise server 130 may be any computing device that is capable of communicating with the computing device 110 via the network 120. For example, the enterprise server 130 may be an on-premises server or a cloud server. It should be appreciated that, although a single enterprise server 130 is shown in FIG. 1, the enterprise server may include a family of servers. The enterprise server 130 may include a communication interface 132, a processor 134, and a computer-readable storage 136. In examples, the communication interface 132 may be coupled to a network and receive a user input from another computing device (e.g., 110).

In examples, one or more applications 138 may be provided by the enterprise server 130. In the illustrative aspect, the one or more applications 138 include a question receiver 140, a knowledge graph manager 142, a question-answer generator 144, and a question analysis module 146. The question receiver 140 is configured to receive a user question posted by the user 112 seeking for an answer or information related to the question.

The knowledge graph manager 142 is configured to generate, provide, and/or update an enterprise knowledge graph 142 that is unique to the enterprise and is based on a variety of sources within the enterprise, such as file systems, intranets, document management systems, e-mail, and databases. In some aspects, the knowledge graph manager 142 is configured to search the enterprise knowledge graph 142 in response to receiving the user question in order to find an answer. In some aspects, the knowledge graph manager 142 is configured to update the enterprise knowledge graph 142 based on user feedback. For example, the knowledge graph manager 142 may request and receive user feedback from user 112 regarding user satisfaction with an answer to the user question. In some aspects, the knowledge graph manager 142 may request and receive user feedback from user 112 regarding user satisfaction with one or more experts recommended to answer the user question. The user feedback may be used to predict a level of expertise for the particular expert, collect the question and answer pair to associate it with the particular topic, and/or associate the expert with the topic. This allows the enterprise server 130 to answer similar questions in the future.

The question-answer generator 144 is configured to generate a new frequently-asked-questions (FAQ) in response to determining that the suggested topic does not have an existing FAQ with Q&A history. To do so, the question-answer generator 144 may generate the new FAQ from contents within enterprise documents linked to the suggested topic based on the user question and the provided answer (e.g., predicted answer).

The question analysis module 146 is configured to analyze the user question seeking an answer or relevant information. To do so, the question analysis module 146 further includes a question topic classifier 148, a question-answer identifier 150, and an expert identifier 152.

The question topic classifier 148 is configured to analyze the user question to determine a suggested topic associated with the user question based on the enterprise knowledge graph 142 stored in a database 140 accessible to the enterprise server 130 via the network 120. As described above, the user may post the question without selecting or specifying a topic related to the user question. In other aspects, the use may be prompted to confirm, input, or select a topic related to the user question.

In the illustrative aspect, the enterprise knowledge graph 142 may classify contents of the various enterprise sources (e.g., file systems, intranets, document management systems, e-mail, and databases) in order to establish relationships between the contents based on topics. These relationships may be determined based on natural language processing or other analysis of the contents, for example. In some aspects, the question topic classifier 148 may be configured to rely on keywords or noun phrases associated with the user question to identify contents within enterprise documents to find one or more topics associated with the user question. For example, the question topic classifier 148 may determine whether named entity references in the question match the knowledge graph entities. In other example, the question topic classifier 148 may match a semantic representation of the question with the topic based on semantic transformer language models. Alternatively, rather than relying on keywords or noun phrases, the question topic classifier 148 may be configured to paraphrase the user question (e.g., transform the user question into a semantic representation) to identify contents within enterprise documents associated with a plurality of similar entities, where similar entities may be classified under or related to particular topics. For example, the user question may state “What is Cortex?” The question topic classifier 148 may search for “Cortex is” in the enterprise documents. By doing so, the question topic classifier 148 may directly find related enterprise documents that may include an answer to the user question. The identified topics may then be provided to the user as one or more suggested topics. In some aspects, the user may be prompted to confirm or select a topic from the one or more suggested topics.

The question-answer determiner 150 is configured to find one or more relevant or similar question and answer (Q&A) pairs linked to the suggested topic that were previously asked by other users 114 in the enterprise based on the enterprise knowledge graph 142. In some aspects, the question-answer determiner 150 is configured to use specific keywords or noun phrases of the user question to find one or more questions that have the explicitly matching keywords or noun phrases. In other aspects, instead of relying on the specific keywords or noun phrases, the question-answer determiner 150 is configured to find a similar question in Q&A history associated with the suggested topic by paraphrasing contents of the user question (e.g., transform the user question into a semantic representation). For example, the question-answer determiner 150 may compare and match semantic representations of the user question with the previously asked questions on the same topic. As such, paraphrasing the contents allows the question-answer determiner 150 to identify one or more questions that are similar or related to the user question within the enterprise knowledge graph 142 rather than identifying one or more questions that have explicitly matching keywords or noun phrases.

In certain aspects, the question-answer determiner 150 is configured to find an answer to the user question. For example, the question-answer determiner 150 may find an answer explicitly in the contents in related documents linked to the suggested topic from the enterprise knowledge graph 142. Alternatively, the question-answer determiner 150 may paraphrase contents of the user question (e.g., transform into a semantic representation) and find an answer in the related documents from the enterprise knowledge graph 142. To do so, the question-answer determiner 150 may first identify documents within the enterprise, such as file systems, intranets, document management systems, e-mail, and databases, that are associated with the suggested topic and determine contents in the identified documents to find an answer to the user question.

The expert identifier 152 is configured to determine one or more experts to answer the user question by identifying related people from the enterprise knowledge graph 142. For example, the related people may be detected from classifications in the enterprise knowledge graph. Additionally, the related people may also be identified by analyzing metadata of the relevant documents associated with the suggested topic. For example, the metadata may include authors, dates, revision dates, titles, fields, and/or indication of a certain site/group. The one or more experts may also be determined based on availability and/or likelihood of the related people to provide an answer. The expert identifier 152 is further configured to provide or display the one or more experts to the user 112. The expert identifier 152 is configured to seamlessly integrate human feedback and direct communication with experts when an answer is not identified in the enterprise knowledge graph 142. For example, the expert identifier 152 may identify the expert, automatically send an email to the expert introducing the user 112, and provide the user question.

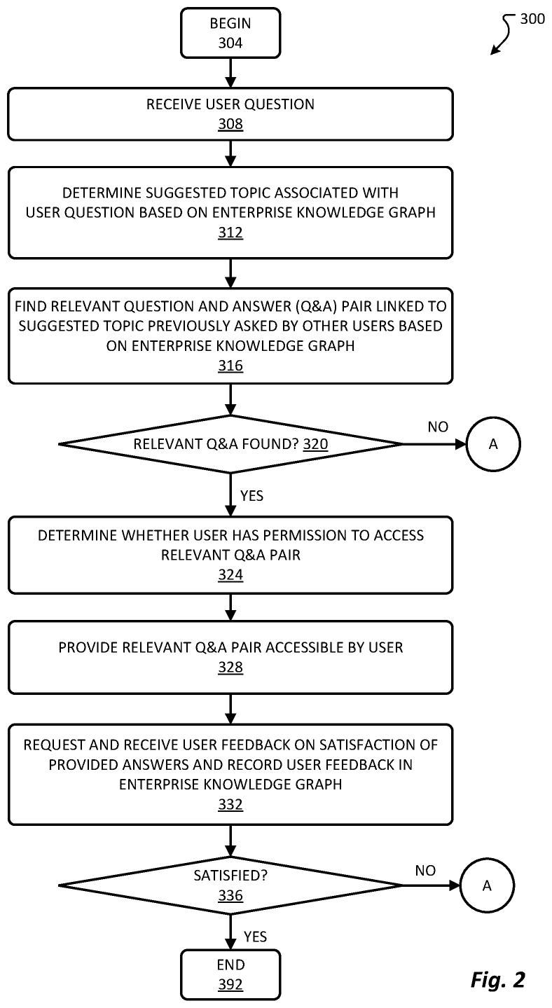

Referring now to FIGS. 2-4, a method 300 for facilitating obtaining answers to user questions within an enterprise based on an enterprise knowledge graph in accordance with examples of the present disclosure is provided. A general order for the steps of the method 300 is shown in FIGS. 2-4. Generally, the method 300 starts at 304 and ends at 392. The method 300 may include more or fewer steps or may arrange the order of the steps differently than those shown in FIGS. 2-4. In the illustrative aspect, the method 300 is performed by an enterprise server (e.g., 130) associated with the enterprise. For example, the enterprise server 130 may be any suitable server computing device that is capable of communicating with a client computing device (e.g., device 110) associated with a user (e.g., user 112). For example, the client computing device may be, but is not limited to, a computer, a notebook, a laptop, a mobile device, a smartphone, a tablet, wearable, or any other suitable computing device that is capable of communicating with the enterprise server 130. The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIG. 1.

The method 300 starts at 304, where flow may proceed to 308. At operation 308, an enterprise server (e.g., enterprise server 130) receives a user question from a computing device 110 associated with a member of an enterprise (e.g., a user 112). For example, the user may post a question on an enterprise server platform executed by the enterprise server and may seek an answer, a predicted answer, or information related to the question. Specifically, in the illustrative embodiment, the enterprise server platform allows the user to post the question without selecting or specifying a related topic, or specifying where to post the question (e.g., to which community or group in the enterprise), and/or to whom to address the question (e.g., which people in the enterprise) in order to obtain an answer or relevant information.

In response to receiving the user question, at operation 312, the enterprise server may determine a suggested topic associated with the user question based on an enterprise knowledge graph. As described above, the enterprise knowledge graph is unique to the enterprise and is based on a variety of sources within the enterprise, such as file systems, intranets, document management systems, e-mail, and databases. In the illustrative embodiment, the enterprise server may classify contents of the various enterprise sources (e.g., file systems, intranets, document management systems, e-mail, and databases) in order to establish relationships between the contents based on topics. These relationships may be determined based on natural language processing or other analysis of the contents, for example. In this case, rather than relying on keywords or noun phrases, the enterprise server may paraphrase the user question (e.g., transform the user question into a semantic representation) to identify contents within enterprise documents associated with a plurality of similar entities, where similar entities may be classified under or related to particular topics. To do so, the enterprise server may transform the user question into a semantic representation and match it to representations of topics in the enterprise knowledge graph and/or enterprise documents linked to those topics. The identified topics may then be provided to the user as one or more suggested topics. It should be appreciated that, in some embodiments, the enterprise server may determine that the user question is associated with multiple suggested topics. In some embodiments, the enterprise server may suggest one or more topics to the user and the user may select a desired topic. If the desired topic is not provided in the one or more suggested topics, the user may be prompted to input a topic related to the question.

At operation 316, the enterprise server 130 finds one or more relevant or similar question and answer (Q&A) pairs linked to the suggested topic that were previously asked by other users (e.g., other users 114) in the enterprise based on the enterprise knowledge graph. In some embodiments, the enterprise server may use specific keywords or noun phrases of the user question to find one or more questions that have the explicitly matching keywords or noun phrases. However, in the illustrative embodiment, instead of relying on the specific keywords or noun phrases, the enterprise server 130 finds a similar question in Q&A history associated with the suggested topic by paraphrasing the user question (e.g., matching semantic representations). As such, paraphrasing the contents allows the enterprise server to identify one or more questions that are similar or related to the user question within the enterprise knowledge graph rather than identifying one or more questions that have explicitly matching keywords or noun phrases.

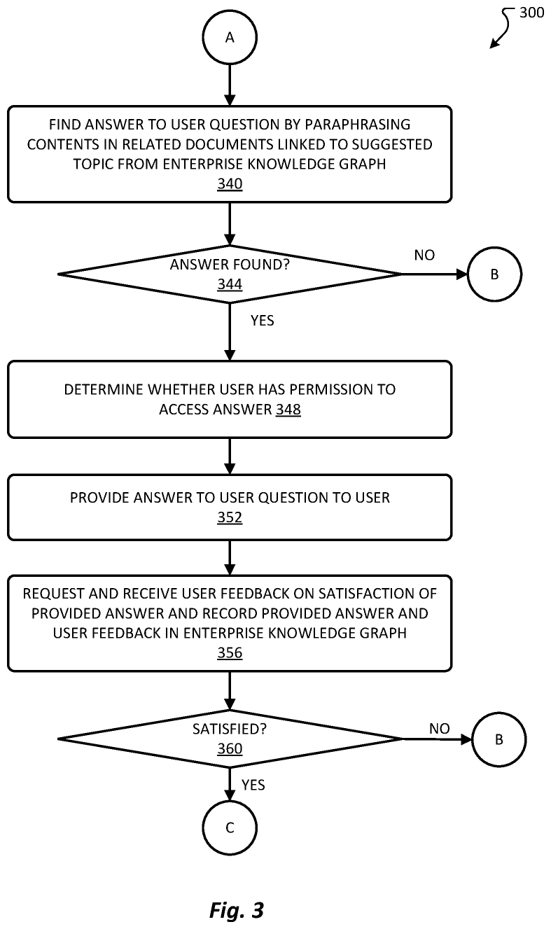

If the enterprise server determines that a relevant or similar Q&A pair was not found in operation 320, the method 300 skips ahead to operation 340 in FIG. 3 as shown by the alphanumeric character A in FIGS. 2 and 3. If, however, the enterprise server determines that one or more relevant Q&A pairs are found in operation 320, the method 300 advances to operation 324.

At operation 324, the enterprise server may determine whether the user has permission to access at least one of the one or more relevant Q&A pairs. For example, different permission levels may be set by the enterprise to limit access to certain information within the enterprise. In response to determining that the user has permissions, the enterprise server may provide one or more relevant Q&A pairs accessible by the user, as indicated in operation 328. For example, the one or more relevant Q&A pairs may be presented to the user 112 via a display screen of the computing device.

Subsequently, at operation 332, the enterprise server may request and receive user feedback regarding user satisfaction with the provided answer (Q&A) and the user feedback may be recorded in the enterprise knowledge graph. At operation 336, the enterprise server determines whether the user is satisfied with the one or more provided answers based on the feedback. If the enterprise server determines that the user is satisfied, the method 300 skips ahead and ends at 392. If, however, the enterprise server determines that the user is dissatisfied, the method 300 advances to operation 340 in FIG. 3 as shown by the alphanumeric character A in FIGS. 2 and 3. For example, the user may request help from an expert if the provided answer is insufficient.

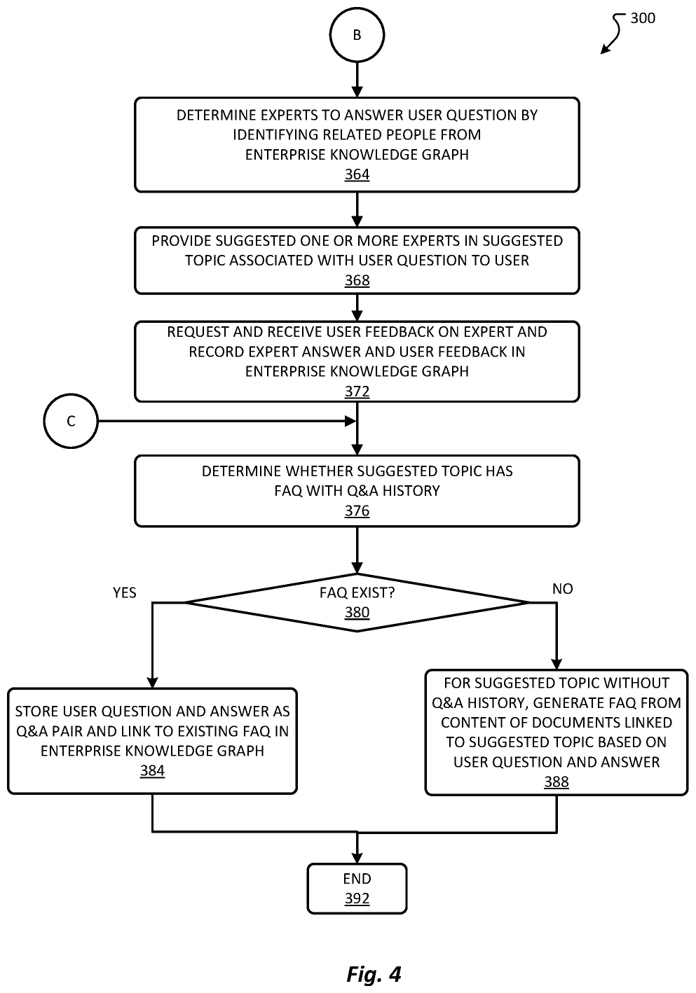

At operation 340, the enterprise server 130 finds an answer (e.g., predicted answer) to the user question by paraphrasing contents (e.g., transforming into semantic representations) in related documents within the enterprise linked to the suggested topic from the enterprise knowledge graph. To do so, the enterprise server 130 may first identify documents within the enterprise, such as file systems, intranets, document management systems, e-mail, and databases, that are associated with the suggested topic and paraphrase contents in the identified documents to find an answer (e.g., predicted answer) to the user question (e.g., transform contents into semantic representations). Subsequently, the enterprise server 130 matches the paraphrased user question (e.g., a semantic representation of the user question) to the one or more related enterprise documents. If the enterprise server does not find the answer in operation 344, the method 300 skips ahead to operation 364 in FIG. 4 as shown by the alphanumeric character B in FIGS. 3 and 4. If, however, the enterprise server finds an answer in operation 344, the method 300 proceeds to operation 348.

At 348, the enterprise server 130 determines whether the user has permission to access the answer. In response to determining that the user has permission, the enterprise server provides the answer (e.g., predicted answer) to the user, as indicated in operation 352. For example, the one or more relevant Q&A pairs may be presented to the user via a display screen of the computing device.

Subsequently, at operation 356, the enterprise server may request and receive feedback regarding user satisfaction with the provided answer and may record the provided answer and the user feedback in the enterprise knowledge graph. It should be appreciated that, in some aspects, the provided answer may be recorded in the enterprise knowledge graph in response to receiving a positive feedback from the user on the provided answer. At operation 360, the enterprise server determines whether the user is satisfied with the provided answer based on the feedback. If the enterprise server determines that the user is satisfied, the method 300 proceeds to operation 376 in FIG. 4 as shown by the alphanumeric character C in FIGS. 3 and 4. If, however, the enterprise server 130 determines that the user is dissatisfied, the method 300 advances to operation 364 in FIG. 4 as shown by the alphanumeric character B in FIGS. 3 and 4. For example, the user may request help from an expert if the provided answer is insufficient.

At operation 364, the enterprise server may determine one or more experts to answer the user question by identifying related people from the enterprise knowledge graph. For example, the related people may be detected from classifications in the enterprise knowledge graph. Additionally, the related people may also be identified by analyzing metadata of the relevant documents associated with the suggested topic. For example, the metadata may include authors, dates, revision dates, titles, fields, and/or indication of a certain site/group. The one or more experts may be determined based on availability and/or likelihood of the related people to provide an answer. At operation 368, the enterprise server provides the one or more experts in the suggested topic associated with the user question to the user. Additionally, the enterprise server may automatically send an email to the one or more experts introducing the user and provide the user question to the one or more experts. This allows the Q&A system to seamlessly integrate human feedback and direct communication with experts when an answer is not identified in the enterprise knowledge graph.

At operation 372, the enterprise server may request and receive feedback on user satisfaction with the provided one or more experts and may record an answer provided by the expert and the user feedback in the enterprise knowledge graph. For example, the user feedback may include user experience with the one or more experts, including whether the expert was capable and able to provide an answer to the user question. Additionally, in response to receiving the user feedback (e.g., a rating) on the expert, the enterprise server may update or adjust a relevance weight of the expert in the enterprise knowledge graph based on the feedback. For example, the relevance weight of the expert may be for the suggested topic, similar questions, and/or in general for all questions (e.g., a static rank score). The feedback may include a quality of an answer provided by the expert. However, in some examples, the feedback may indicate when the expert does not provide an answer and/or wishes not to be disturbed with subsequent questions. It should be appreciated that, in some aspects, the answer provided by the expert is recorded in response to receiving positive feedback from the user to the expert answer, which may cause a relevance weight of the expert to be updated in the enterprise knowledge graph based on the feedback.

At operation 376, the enterprise server may determine whether the suggested topic has an existing FAQ with Q&A history. If the enterprise server determines that the suggested topic has an existing FAQ with Q&A history, the method 300 proceeds to operation 384. At operation 384, the enterprise server 130 stores the user question and the provided answer as a Q&A pair and link to the existing FAQ associated with the suggested topic in the enterprise knowledge graph.

If, however, the suggested topic does not have a Q&A history, the method 300 advances to operation 388 to generate a new FAQ from content within enterprise documents linked to the suggested topic based on the user question and the provided answer (e.g., predicted answer), as indicated in operation 388. As an example, the enterprise server may generate a new FAQ associated with the suggested topic from the contents within the enterprise documents that are linked to the suggested topic based on the user question and the provided answer and update the enterprise knowledge graph based on the new FAQ. It should be appreciated that updating the enterprise knowledge graph based on the user question and the provided answer may include linking the suggested topic to the user question and the provided answer in the enterprise knowledge graph. In another example, the enterprise server may generate a new FAQ associated with the suggested topic based on the user question and an answer received from the expert and update the enterprise knowledge graph to add the new FAQ. It should be appreciated that updating the enterprise knowledge graph based on the user question and the expert answer may include linking the suggested topic to the user question and the expert answer in the enterprise knowledge graph.

Subsequently, the method 300 may end at 392. In other words, by utilizing the enterprise knowledge graph, the enterprise server may provide answers or relevant information to a user question even if the question had never previously been asked by other users.

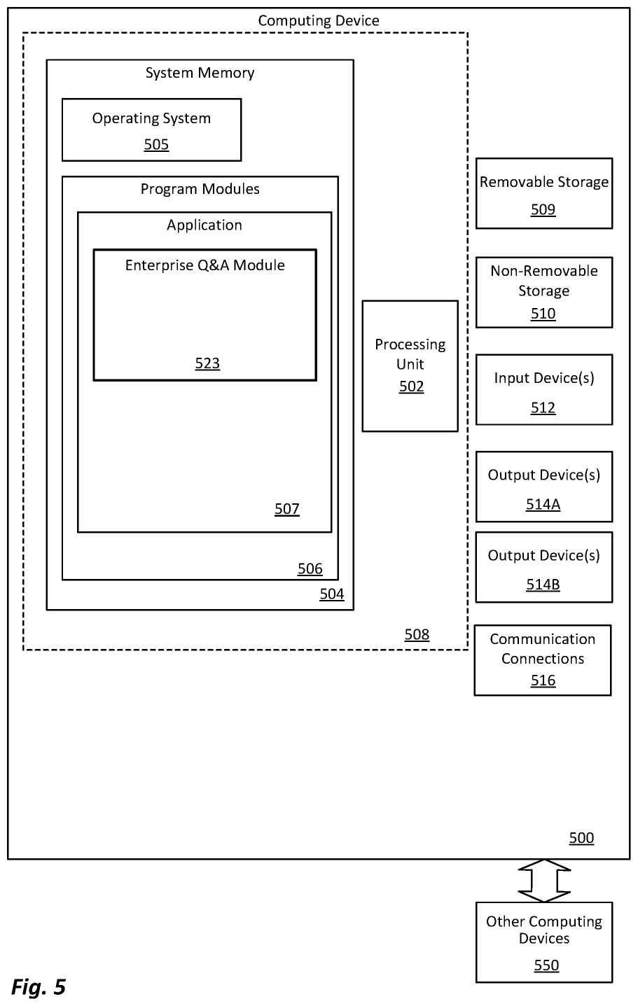

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above. For example, the computing device 500 may represent the computing device 110 of FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for performing the various aspects disclosed herein such. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, several program modules and data files may be stored in the system memory 504. While executing on the at least one processing unit 502, the program modules 506 may perform processes including, but not limited to, one or more aspects, as described herein. The application 520 includes an enterprise Q&A module 523 that is configured to communicate with one or more applications 138 of the enterprise server 130, as described in more detail with regard to FIG. 1. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514A such as a display, speakers, a printer, etc. may also be included. An output 514B, corresponding to a virtual display may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

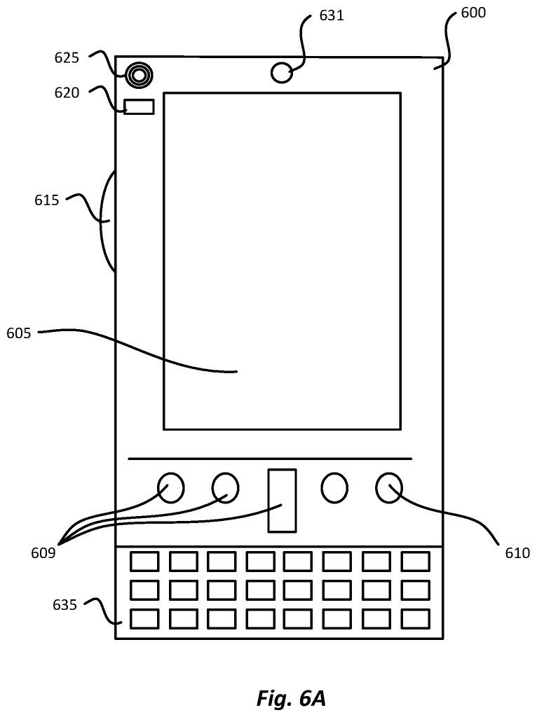

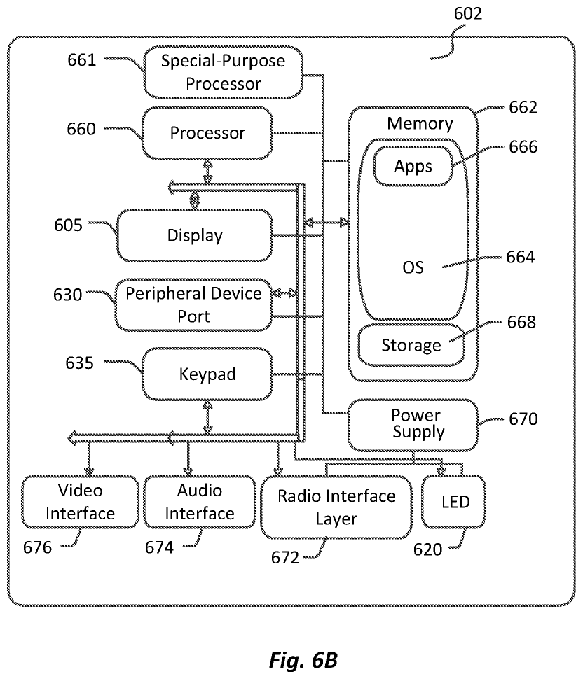

FIGS. 6A and 6B illustrate a computing device or mobile computing device 600, for example, a mobile telephone, a smart phone, wearable computer (such as a smart watch), a tablet computer, a laptop computer, and the like, with which aspects of the disclosure may be practiced. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 609/610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display. In various aspects, the output elements include the display 605 for showing a graphical user interface (GUI), a visual indicator 631 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports 630, such as an audio input (e.g., a microphone jack), an audio output (e.g., a headphone jack), and a video output (e.g., a HDMI port) for sending signals to or receiving signals from an external source.

FIG. 6B is a block diagram illustrating the architecture of one aspect of computing device, a server, or a mobile computing device. That is, the mobile computing device 600 can incorporate a system (902) (e.g., an architecture) to implement some aspects. The system 602 can implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and/or one or more components supported by the systems described herein. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g. an enterprise Q&A module 523, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated configuration, the visual indicator 620 is a light emitting diode (LED) and the audio transducer 625 is a speaker. These devices may be directly coupled to the power supply 670 so that when activated, they remain on for a duration dictated by the notification mechanism even though the processor 660/661 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with aspects of the present disclosure, the microphone may also serve as an audio sensor to facilitate control of notifications, as will be described below. The system 602 may further include a video interface 676 that enables an operation of an on-board camera to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

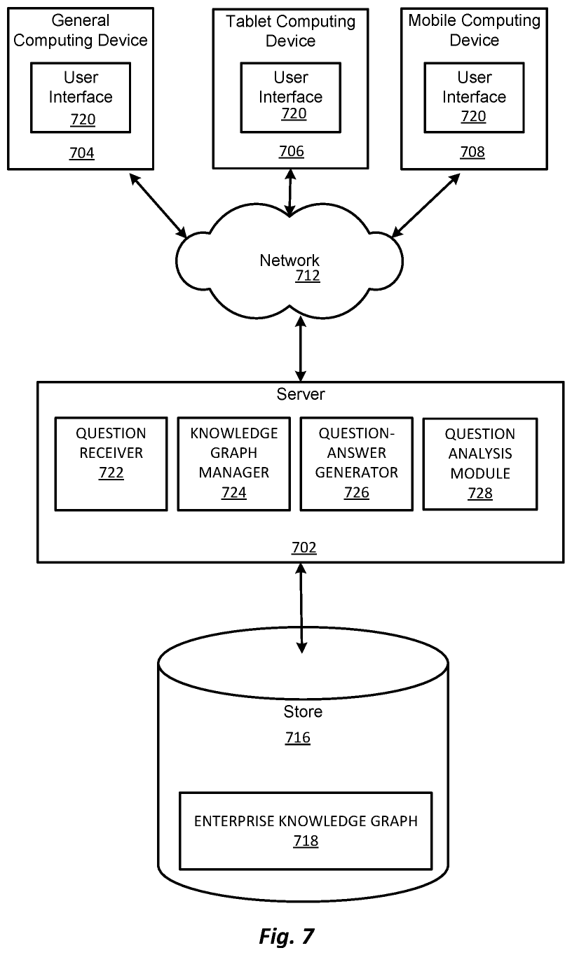

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, the computing device 704, 706, 708 may represent the computing device 110 of FIG. 1, and the server device 702 may represent the enterprise server 130 of FIG. 1.

In some aspects, one or more of a question receiver 722, a knowledge graph manager 724, a question-answer generator 726, and a question analysis module 728, may be employed by server device 702. The server device 702 may provide data to and from a client computing device such as a personal computer 704, a tablet computing device 706 and/or a mobile computing device 708 (e.g., a smart phone) through a network 712. By way of example, the computer system described above may be embodied in a personal computer 704, a tablet computing device 706 and/or a mobile computing device 708 (e.g., a smart phone). Any of these aspects of the computing devices may obtain content from the store 716, in addition to receiving graphical data useable to be either pre-processed at a graphic-originating system, or post-processed at a receiving computing system. The content store may include enterprise knowledge graph 718.

FIG. 7 illustrates an exemplary mobile computing device 708 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for facilitating an enterprise user to obtain an answer to a user question within an enterprise based on an enterprise knowledge graph is provided. The method may include receiving the user question from the enterprise user, determining a suggested topic associated with the user question based on the enterprise knowledge graph by transforming the user question into a semantic representation to identify a plurality of similar entities within the enterprise knowledge graph, determining whether a relevant question-and-answer (Q&A) pair linked to the suggested topic exists based on the enterprise knowledge graph, in response to determining that the relevant Q&A pair does not exist, determining a predicted answer to the user question by identifying one or more related enterprise documents linked to the suggested topic based on the enterprise knowledge graph and finding the predicted answer by matching the semantic representation of the user question to a corresponding semantic representation in the one or more related enterprise documents, updating the enterprise knowledge graph based on the user question and the predicted answer, and in response to determining the predicted answer to the user question, causing the predicted answer to be provided to the enterprise user.

In accordance with at least one aspect of the above method, the method may include where identifying the plurality of similar entities within the enterprise knowledge graph to provide the suggested topic comprises identifying contents within enterprise documents that are related to the user question using the enterprise knowledge graph, identifying a topic linked to the identified contents, and linking the identified topic as a suggested topic associated with the user question.

In accordance with at least one aspect of the above method, the method may include finding the relevant Q&A pair linked to the suggested topic comprises finding a similar question by transforming questions that have previously been asked by other enterprise users into a semantic representation and matching sematic representations of the user question and the questions that have previously been asked by other enterprise users.

In accordance with at least one aspect of the above method, the method may further include generating, in response to determining the predicted answer to the user question, a new frequently asked question (FAQ) associated with the suggested topic from the contents within the enterprise documents that are linked to the suggested topic based on the user question and the predicted answer and updating the enterprise knowledge graph based on the new FAQ. In accordance with at least one aspect of the above method, the method may include where updating the enterprise knowledge graph based on the user question and the predicted answer comprises linking the suggested topic to the user question and the predicted answer.

In accordance with at least one aspect of the above method, the method may further include determining, prior to providing the predicted answer to the enterprise user, whether the enterprise user has permission to access the predicted answer.

In accordance with at least one aspect of the above method, the method may further include determining, in response to determining that the relevant Q&A pair exists, whether the enterprise user has permission to access the relevant Q&A pair and providing, in response to determining the enterprise user has permission, an answer from the relevant Q&A pair to the enterprise user.

In accordance with at least one aspect of the above method, the method may further include requesting, subsequent to providing the predicted answer to the enterprise user, a feedback on satisfaction from the enterprise user, receiving the feedback from the enterprise user, and updating the enterprise knowledge graph based on the feedback.

In accordance with at least one aspect of the above method, the method may further include determining, in response to determining the predicted answer to the user question cannot be determined from the enterprise knowledge graph, an expert to answer the user question by identifying related people from the enterprise knowledge graph, requesting a feedback on at least one of a quality of an answer provided by the expert or an overall user experience with the expert, receiving the feedback from the enterprise user, updating the enterprise knowledge graph to add the answer provided by the expert and the feedback, and adjusting a relevance weight of the expert in the enterprise knowledge graph based on the feedback.

In accordance with at least one aspect of the above method, the method may include where determining the expert to answer the user question comprises determining the expert based on availability and likelihood of the related people to answer the user question.

In accordance with at least one example of the present disclosure, a computing device for facilitating an enterprise user to obtain an answer to a user question within an enterprise based on an enterprise knowledge graph is provided. The computing device may include a processor and a memory having a plurality of instructions stored thereon that, when executed by the processor, causes the computing device to receive the user question from the enterprise user, determine a suggested topic associated with the user question based on the enterprise knowledge graph by paraphrasing the user question to identify a plurality of similar entities within the enterprise knowledge graph to provide the suggested topic, determine whether a relevant question-and-answer (Q&A) pair linked to the suggested topic exists based on the enterprise knowledge graph, in response to determination that the relevant Q&A pair does not exist, determine a predicted answer to the user question by identifying one or more related enterprise documents linked to the suggested topic based on the enterprise knowledge graph and finding the predicted answer by matching the paraphrased user question to the one or more related enterprise documents, update the enterprise knowledge graph based on the user question and the predicted answer, and in response to determination of the predicted answer to the user question, cause the predicted answer to be provided to the enterprise user.

In accordance with at least one aspect of the above computing device, the computing device may include where to identify the plurality of similar entities within the enterprise knowledge graph to provide the suggested topic comprises to identify contents within enterprise documents that are related to the user question using the enterprise knowledge graph, identify a topic linked to the identified contents, and link the identified topic as a suggested topic associated with the user question.

In accordance with at least one aspect of the above computing device, the computing device may include where to find the relevant Q&A pair linked to the suggested topic comprises to find a similar question by transforming the user question and questions that have previously been asked by other enterprise users into semantic representations. In accordance with at least one aspect of the above computing device, the computing device may include where finding the predicted answer by matching the paraphrased user question to the one or more related enterprise documents comprises finding the predicted answer by matching the semantic representation of the user question to a corresponding semantic representation in the one or more related enterprise documents.

In accordance with at least one aspect of the above computing device, the computing device may further be configured to generate, in response to determining the predicted answer to the user question, a new frequently asked question (FAQ) associated with the suggested topic from the contents within the enterprise documents that are linked to the suggested topic based on the user question and the predicted answer and update the enterprise knowledge graph based on the new FAQ. In accordance with at least one aspect of the above computing device, the computing device may include where to update the enterprise knowledge graph based on the user question and the predicted answer comprises to link the suggested topic to the user question and the predicted answer.

In accordance with at least one aspect of the above computing device, the computing device may further be configured to determine, in response to determination that the relevant Q&A pair exists, whether the enterprise user has permission to access the relevant Q&A pair and provide, in response to determination that the enterprise user has permission, the relevant Q&A pair to the enterprise user.

In accordance with at least one aspect of the above computing device, the computing device may further be configured to request, subsequent to providing the predicted answer to the enterprise user, a feedback on satisfaction from the enterprise user, receive the feedback from the enterprise user, and update the enterprise knowledge graph based on the feedback.

In accordance with at least one aspect of the above computing device, the computing device may further be configured to determine, in response to determination that the predicted answer to the user question cannot be determined from the enterprise knowledge graph, an expert to answer the user question by identifying related people from the enterprise knowledge graph, request a feedback on a quality of an answer provided by the expert and/or an overall user experience with the expert, receive the feedback from the enterprise user, update the enterprise knowledge graph to add the answer provided by the expert and the feedback, and adjust a relevance weight of the expert in the enterprise knowledge graph based on the feedback.

In accordance with at least one aspect of the above computing device, the computing device may include where to determine the expert to answer the user question comprises to determine the expert based on availability and likelihood of the related people to answer the user question.

In accordance with at least one example of the present disclosure, a non-transitory computer-readable medium storing instructions for facilitating an enterprise user to obtain an answer to a user question within an enterprise based on an enterprise knowledge graph is provided. The instructions when executed by one or more processors of a computing device, cause the computing device to receive the user question from the enterprise user, determine a suggested topic associated with the user question based on the enterprise knowledge graph by paraphrasing the user question to identify a plurality of similar entities within the enterprise knowledge graph to provide the suggested topic, determine whether a relevant question-and-answer (Q&A) pair linked to the suggested topic exists based on the enterprise knowledge graph, in response to determination that the relevant Q&A pair does not exist, determine an expert to answer the user question by identifying related people from the enterprise knowledge graph, in response to receipt of an expert answer, update the enterprise knowledge graph based on the user question and the expert answer, and cause the expert answer to be provided to the enterprise user, wherein determining the expert to answer the user question comprises determining the expert based on availability and likelihood of the related people to answer the user question.

In accordance with at least one aspect of the above non-transitory computer-readable medium, the instructions when executed by the one or more processors may further cause the computing device to receive a confirmation of the suggested topic from the user.

In accordance with at least one aspect of the above non-transitory computer-readable medium, the instructions when executed by the one or more processors may further cause the computing device to request a feedback on at least one of a quality of an answer provided by the expert or an overall user experience with the expert, receive the feedback from the enterprise user, update the enterprise knowledge graph to add the answer provided by the expert and the feedback, and adjust a relevance weight of the expert in the enterprise knowledge graph based on the feedback.

In accordance with at least one aspect of the above non-transitory computer-readable medium, the instructions when executed by the one or more processors may further cause the computing device to generate, in response to determination of the predicted answer to the user question, a new frequently asked question (FAQ) associated with the suggested topic based on the user question and the expert answer and update the enterprise knowledge graph based on the new FAQ.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

1. A method for facilitating an enterprise user to obtain an answer to a user question within an enterprise based on an enterprise knowledge graph, the method comprising:
receiving the user question from the enterprise user;
determining a suggested topic associated with the user question based on the enterprise knowledge graph by transforming the user question into a semantic representation to identify a plurality of similar entities within the enterprise knowledge graph;
determining whether a relevant question-and-answer (Q&A) pair linked to the suggested topic exists based on the enterprise knowledge graph;
in response to determining that the relevant Q&A pair does not exist, determining a predicted answer to the user question by:
identifying one or more related enterprise documents linked to the suggested topic based on the enterprise knowledge graph; and
finding the predicted answer by matching the semantic representation of the user question to a corresponding semantic representation in the one or more related enterprise documents;
updating the enterprise knowledge graph based on the user question and the predicted answer; and
in response to determining the predicted answer to the user question, causing the predicted answer to be provided to the enterprise user.

2. The method of claim 1, wherein identifying the plurality of similar entities within the enterprise knowledge graph to provide the suggested topic comprises:
identifying contents within enterprise documents that are related to the user question using the enterprise knowledge graph;
identifying a topic linked to the identified contents; and
linking the identified topic as a suggested topic associated with the user question.

3. The method of claim 1, wherein finding the relevant Q&A pair linked to the suggested topic comprises finding a similar question by transforming questions that have previously been asked by other enterprise users into a semantic representation and matching sematic representations of the user question and the questions that have previously been asked by other enterprise users.

4. The method of claim 1, further comprising:
generating, in response to determining the predicted answer to the user question, a new frequently asked question (FAQ) associated with the suggested topic from the contents within the enterprise documents that are linked to the suggested topic based on the user question and the predicted answer; and
updating the enterprise knowledge graph based on the new FAQ,
wherein updating the enterprise knowledge graph based on the user question and the predicted answer comprises linking the suggested topic to the user question and the predicted answer in the enterprise knowledge graph.

5. The method of claim 1, further comprising determining, prior to providing the predicted answer to the enterprise user, whether the enterprise user has permission to access the predicted answer.

6. The method of claim 1, further comprising:
determining, in response to determining that the relevant Q&A pair exists, whether the enterprise user has permission to access the relevant Q&A pair; and
providing, in response to determining the enterprise user has permission, an answer from the relevant Q&A pair to the enterprise user.

7. The method of claim 1, further comprising:
requesting, subsequent to providing the predicted answer to the enterprise user, a feedback on satisfaction from the enterprise user;
receiving the feedback from the enterprise user; and
updating the enterprise knowledge graph based on the feedback.

8. The method of claim 1, further comprising:
determining, in response to determining the predicted answer to the user question cannot be determined from the enterprise knowledge graph, an expert to answer the user question by identifying related people from the enterprise knowledge graph;
requesting a feedback on at least one of a quality of an answer provided by the expert or an overall user experience with the expert;
receiving the feedback from the enterprise user;
updating the enterprise knowledge graph to add the answer provided by the expert and the feedback; and
adjusting a relevance weight of the expert in the enterprise knowledge graph based on the feedback.

9. The method of claim 8, wherein determining the expert to answer the user question comprises determining the expert based on availability and likelihood of the related people to answer the user question.

10. A computing device for facilitating an enterprise user to obtain an answer to a user question within an enterprise based on an enterprise knowledge graph, the computing device comprising:
a processor; and
a memory having a plurality of instructions stored thereon that, when executed by the processor, causes the computing device to:
receive the user question from the enterprise user;
determine a suggested topic associated with the user question based on the enterprise knowledge graph by paraphrasing the user question to identify a plurality of similar entities within the enterprise knowledge graph to provide the suggested topic;
determine whether a relevant question-and-answer (Q&A) pair linked to the suggested topic exists based on the enterprise knowledge graph;
in response to determination that the relevant Q&A pair does not exist, determine a predicted answer to the user question by:
identifying one or more related enterprise documents linked to the suggested topic based on the enterprise knowledge graph; and
finding the predicted answer by matching the paraphrased user question to the one or more related enterprise documents;
update the enterprise knowledge graph based on the user question and the predicted answer; and
in response to determination of the predicted answer to the user question, cause the predicted answer to be provided to the enterprise user.

11. The computing device of claim 10, wherein to identify the plurality of similar entities within the enterprise knowledge graph to provide the suggested topic comprises to:
identify contents within enterprise documents that are related to the user question using the enterprise knowledge graph;
identify a topic linked to the identified contents; and
link the identified topic as a suggested topic associated with the user question.

12. The computing device of claim 10, wherein to find the relevant Q&A pair linked to the suggested topic comprises to find a similar question by transforming the user question and questions that have previously been asked by other enterprise users into semantic representations,
wherein finding the predicted answer by matching the paraphrased user question to the one or more related enterprise documents comprises finding the predicted answer by matching the semantic representation of the user question to a corresponding semantic representation in the one or more related enterprise documents.

13. The computing device of claim 10, wherein the computing device is further configured to:
generate, in response to determining the predicted answer to the user question, a new frequently asked question (FAQ) associated with the suggested topic from the contents within the enterprise documents that are linked to the suggested topic based on the user question and the predicted answer; and
update the enterprise knowledge graph based on the new FAQ,
wherein to update the enterprise knowledge graph based on the user question and the predicted answer comprises to link the suggested topic to the user question and the predicted answer in the enterprise knowledge graph.

14. The computing device of claim 10, wherein the computing device is further configured to:
determine, in response to determination that the relevant Q&A pair exists, whether the enterprise user has permission to access the relevant Q&A pair; and
provide, in response to determination that the enterprise user has permission, the relevant Q&A pair to the enterprise user.

15. The computing device of claim 10, wherein the computing device is further configured to:
request, subsequent to providing the predicted answer to the enterprise user, a feedback on satisfaction from the enterprise user;
receive the feedback from the enterprise user; and
update the enterprise knowledge graph based on the feedback.

16. The computing device of claim 10, wherein the computing device is further configured to:
determine, in response to determination that the predicted answer to the user question cannot be determined from the enterprise knowledge graph, an expert to answer the user question by identifying related people from the enterprise knowledge graph;
request a feedback on a quality of an answer provided by the expert and/or an overall user experience with the expert;
receive the feedback from the enterprise user;
update the enterprise knowledge graph to add the answer provided by the expert and the feedback; and
adjust a relevance weight of the expert in the enterprise knowledge graph based on the feedback.

17. The computing device of claim 10, wherein to determine the expert to answer the user question comprises to determine the expert based on availability and likelihood of the related people to answer the user question.

18. A non-transitory computer-readable medium storing instructions for facilitating an enterprise user to obtain an answer to a user question within an enterprise based on an enterprise knowledge graph, the instructions when executed by one or more processors of a computing device, cause the computing device to:
receive the user question from the enterprise user;
determine a suggested topic associated with the user question based on the enterprise knowledge graph by paraphrasing the user question to identify a plurality of similar entities within the enterprise knowledge graph to provide the suggested topic;
determine whether a relevant question-and-answer (Q&A) pair linked to the suggested topic exists based on the enterprise knowledge graph;
in response to determination that the relevant Q&A pair does not exist, determine an expert to answer the user question by identifying related people from the enterprise knowledge graph;
in response to receipt of an expert answer, update the enterprise knowledge graph based on the user question and the expert answer; and
cause the expert answer to be provided to the enterprise user,
wherein determining the expert to answer the user question comprises determining the expert based on availability and likelihood of the related people to answer the user question.

19. The non-transitory computer-readable medium of claim 18, the instructions when executed by the one or more processors further causing the computing device to:
receive a confirmation of the suggested topic from the user.

20. The non-transitory computer-readable medium of claim 18, wherein the instructions when executed by the one or more processors further cause the computing device to:
request a feedback on at least one of a quality of an answer provided by the expert or an overall user experience with the expert;
receive the feedback from the enterprise user;
update the enterprise knowledge graph to add the answer provided by the expert and the feedback; and
adjust a relevance weight of the expert in the enterprise knowledge graph based on the feedback.
